(19) United States
(12) Patent Application Publication
(10) Pub. No.: US 2008/0031714 A1
(43) Pub. Date: Feb. 7, 2008

(54) Bale accumulator and method of use thereof

(76) Inventor: Len Cagle, Canton, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 11/499,208

(22) Filed: Aug. 4, 2006

(51) Int. Cl. B66F 9/18

(52) U.S. Cl. 414/607

(57) ABSTRACT

A bale accumulator powered by a skid-steer propulsion unit, wherein bales are gathered and channeled from the field via an enclosed entry section formed by the bale accumulator and the ground. Separator rails are positioned behind the enclosed entry section to facilitate collection of the bales by providing directional selection into channels formed from the sides and center frames of the bale accumulator and the separator bars disposed therebetween. Once a selected number of bales are collected, the bale accumulator is easily lifted off of the bales and pivoted away therefrom, leaving the bales for later collection.

### TECHNICAL FIELD

The present invention relates generally to bale accumulation devices, and more specifically to a hay bale accumulator attached to a skid-steer drive unit, wherein the hay bale accumulator is pushed by the skid-steer drive unit when accumulating hay bales.

### BACKGROUND OF THE INVENTION

During the harvesting of crop grasses, such as hay, straw, alfalfa, etc., it is commonplace to gather the crop grasses into bales to facilitate subsequent transport and/or storage. The crop grasses are typically gathered and formed into a bale by use of a baling machine or baler. The baler may form the bale and deposit it on the ground as it gathers more crop grasses.

The baler may transport the newly-formed bale itself. More often, the baler may have a bale accumulator associated therewith. Previous associated bale accumulation devices have included frameworks for accumulating bales. Alternately, such previous devices are often towed behind a separate tractor or other source of motive power.

Oftentimes, the accumulator is towed behind the bale forming apparatus. For instance, one such bale accumulating device comprises a narrow chute that permits newly-formed bales to slide downward from the towing baler to a diverter arm that causes the bales to enter the selected side of the towed accumulator. Other devices provide conveyors that move the bales upward, where they are positioned by an overhead arm into a collected group. Another similar device towed behind a baler comprises a conveyor that raises newly-formed bales and positions the bales for entry to the bale accumulator between posts that also serve as stops for a diverter bar that selects the channel into which the bales are to be directed as they slide back downward into the bale accumulator.

Still another towed device has hooks that engage the bales from above to thereby carry the bales for transport. Such towed devices may be utilized while the baler is in use forming bales. However, the baler with its towed accumulator is not advantageous for collecting stray bales, or for maneuvering in tight confined spaces. Accordingly, it is often more desirable to utilize the bale forming mechanism separately, while gathering the bales via a separate farm implement, and it is further undesirable to require the baler to be taken out of use to gather such stray or difficult to reach bales.

Yet another device slidably positions channels at the outlet of a chute, wherein the channels subsequently receive the newly-formed bale. Still other devices comprises a chute that receives bales that are already positioned on the ground, wherein the bales travel up the chute and are into a group that is subsequently stacked on a transport platform. The principal disadvantage of such a device is that it requires the bale to be located where the baler can collect it, which may often be off the track of the baler as it cuts and collects crop grasses.

Yet other devices have utilized pointed extensions or deflectors to send the bales from side to side and require a front member that the bales must pass over. Other devices have protruding round members or separator rails that are disposed at the front of the device, or extend forward of the front of the device, thereby requiring high accuracy of positioning to avoid impeding easy collection of the bales. Because such devices lack an entry section enclosed on the top and sides, and by the ground, bales may tumble and jam the apparatus, thereby requiring frequent maintenance.

Yet another device gathers bales on a platform, and then tips the bales forward into a truck-like bed. Such transports may be more efficiently utilized to carry a plurality of bales, rather than for gathering individual bales. Accordingly, it is desirable to have another device that can accumulator the bales before transport.

Some previous devices have included bale handling equipment disposed on the front of a tractor or similar device, wherein the bale handler scoops bales from the ground, or clamps onto bales from above.

Unfortunately, such previous devices require the collection of bales during the baling process, and, thus, must be towed behind the baler in order to receive newly-formed bales. Accordingly, the separate trailer is not advantageously usable to collect stray bales, or bales that have already been deposited by a separate baler.

Therefore, it is readily apparent that there is a need for a device that can rapidly locate and accumulate stray bales, or difficult to reach bales, into an array for later collection, wherein the device can be removed when not in use to permit its propulsion mechanism to perform other duties, and wherein the device is not required to be a part of a baling apparatus that must travel in a fixed course.

### BRIEF SUMMARY OF THE INVENTION

Briefly described, in a preferred embodiment, the present invention overcomes the above-mentioned disadvantages and meets the recognized need for such a device by providing a bale accumulator that is powered by equipment commonly found within the stock located at a farm, wherein the bale accumulator can pursue and collect bales deposited by a baling machine, including stray individual bales or difficult to reach bales.

In the present invention, the bales are gathered and channeled from the field via an enclosure comprising top, bottom and side boundaries formed by a framework and the ground, wherein the size of the enclosure being approximately twice the size of an individual bale facilitates entry of the bales into the framework, while containing the bales therewithin. Positioning of separator rails behind the entry enclosure facilitates collection of bales by providing directional selection into channels via the separator bars.

Once a selected number of bales are collected, the framework is easily lifted off of the bales and pivoted away therefrom, leaving the bales for later collection. By utilizing a skid-steer propulsion unit, the present invention is highly maneuverable and can readily access tight, confined spaces to recover bales therefrom.

According to its major aspects and broadly stated, the present invention in its preferred form is a bale accumulator and method of use thereof, wherein the bale accumulator comprises a bale accumulator comprising a framework and a skid-steer propulsion unit, wherein the framework comprises an enclosed entry section, a plurality of collection sections, and at least one separator defining the collection sections. The enclosed entry section is bordered by a ground surface and the framework. The framework is pushed by the skid-steer propulsion unit. By utilizing an enclosed entry section tumbling of bales id obviated, thereby lessening down time and/or damage to the bales.

The bale accumulator further comprises a front, a rear frame, a left side frame, a right side frame, a center frame and a top. The left and right side frames and the center frame have chamfered leading edges to permit travel over a ground surface whilst minimizing damage thereto. The rear frame has at least one attachment point for connection of a skid-steer propulsion unit thereto. It will be recognized by those skilled in the art that the bale accumulator of the present invention could be attached to other propulsion units, such as, for exemplary purposes only, a front loader of a tractor.

The collection sections comprise channels formed by the separators, wherein at least one separator is disposed between the left side frame and the center frame, and at least one separator is disposed between the right side frame and the center frame. The left, right and center frames each comprise a front rail, the separators each comprise a front rail, wherein the separator front rails are disposed approximately one bale's width aft of the left, right and center frame front rails.

The bale accumulator is utilized by attaching a skid-steer propulsion unit to the bale accumulator and gathering hay bales within the bale accumulator by pushing the bale accumulator across a ground surface and guiding the bale accumulator over the bales, wherein the bales are guided into the enclosed entry section. Bales then impinge on the separator front rails and are turned and/or guided thereby into the receiving channels. The bale accumulator is pushed across the ground surface until a selected quantity of bales has been accumulated. To remove the bale accumulator, it is lifted by the skid-steer propulsion unit above the accumulated bales and moved away from the bales by pivoting the skid-steer propulsion unit.

More specifically, the present invention is a bale accumulator and method of use thereof, wherein the bale accumulator comprises a frame having a back, a front, a left side, a right side, a center section, a left separator, a right separator and a brace. Left and right fillets provide stability and serve to position the center section within the frame. The left and right sides are generally rectangular and comprise a top rail, a bottom rail, a front rail, a rear rail and a chamfer. The center section is generally rectangular and comprises a top rail, a bottom rail, a front rail, a chamfer and the center post portion of the back of the frame The left side, right side and center are parallel to one another and the center is approximately equidistant from the left side and the right side.

The front comprises a top rail. The back comprises a top rail, a bottom rail, a middle rail, the aforementioned center post, a left skid, and a right skid. The back is perpendicular to the left side, the right side and the center, which are fixedly attached to the back by use of welding, fasteners or other securing mechanism as is known in the art to be suitable for forming a rigid frame. A brace and the top rail form a top to the frame and constrain the side front rails equidistant from the center rail.

The left and right separators have bottom guides and front posts, wherein the front posts are positioned approximately one bale width behind the front rails of the sides and the center. The sides, center and separators form channels, and the front portion of the sides and center form enclosed entry sections that are further defined on the bottom by the ground and on the top by the top rail and brace. The brace and top rail further prevent tumbling of a bale once it enters the bale accumulator.

An interface, having left and right portions, is positioned on the back of the frame for attachment of the bale accumulator to a skid-steer propulsion unit, such as, for exemplary purposes only, a BOBCAT skid-steer loader. The skid-steer propulsion unit is removably secured to the bale accumulator, wherein the skid-steer propulsion unit pushes the bale accumulator across the ground over bales for collection thereof.

The bale accumulator is maneuvered such that a bale enters left or right enclosed entry sections and is preferably subsequently easily captured by the bale accumulator. Upon entry, the bale impinges upon left or right front posts and the bale turns and/or passes into one of the channels formed by the sides, the center and the separators. The bale accumulator travels over the bale until the bale reaches the back of the frame, wherein the bale is subsequently carried by the frame back as the bale accumulator is pushed across the ground surface. Once a selected quantity of bales has been accumulated, the bale accumulator is raised above the bales to facilitate easy removal without disturbing bales, and the skid-steer propulsion unit withdraws and pivots away from the accumulated bales. Alternately, the bales can be pushed to a collection point and then released.

The high maneuverability of the skid-steer propulsion unit combination with the bale accumulator serves to permit rapid, easy accumulation of bales even from tight locations that could not otherwise be serviced by large towed bale accumulators.

Accordingly, a feature and advantage of the present invention is its ability to be utilized separate from a baling machine.

Another feature and advantage of the present invention is its ability to be powered by equipment that is commonly found around a farm.

Still another feature and advantage of the present invention is its ability to be easily maneuvered in and out of tight locations.

Yet another feature and advantage of the present invention is its ability to collect previously deposited bales.

Yet still another feature and advantage of the present invention is that it reduces or eliminates damage to ground surfaces.

A further feature and advantage of the present invention is its ability to accumulate bales in an array for subsequent collection/use.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1A depicts a perspective view of a hay bale accumulator according to a preferred embodiment of the present invention;

FIG. 1B is a detail perspective view of an attachment interface for connecting the hay bale accumulator of FIG. 1A to a skid-steer propulsion unit, according to a preferred embodiment of the present invention;

FIG. 2 depicts a perspective view of a hay bale accumulator, driven by a skid-steer propulsion unit, according to a preferred embodiment of the present invention, shown collecting hay bales; and

FIG. 3 depicts a perspective view of a hay bale accumulator, driven by a skid-steer propulsion unit, according to a preferred embodiment of the present invention, shown being lifted off of an accumulated group of hay bales.

### DETAILED DESCRIPTION OF THE PREFERRED AND SELECTED ALTERNATIVE EMBODIMENTS

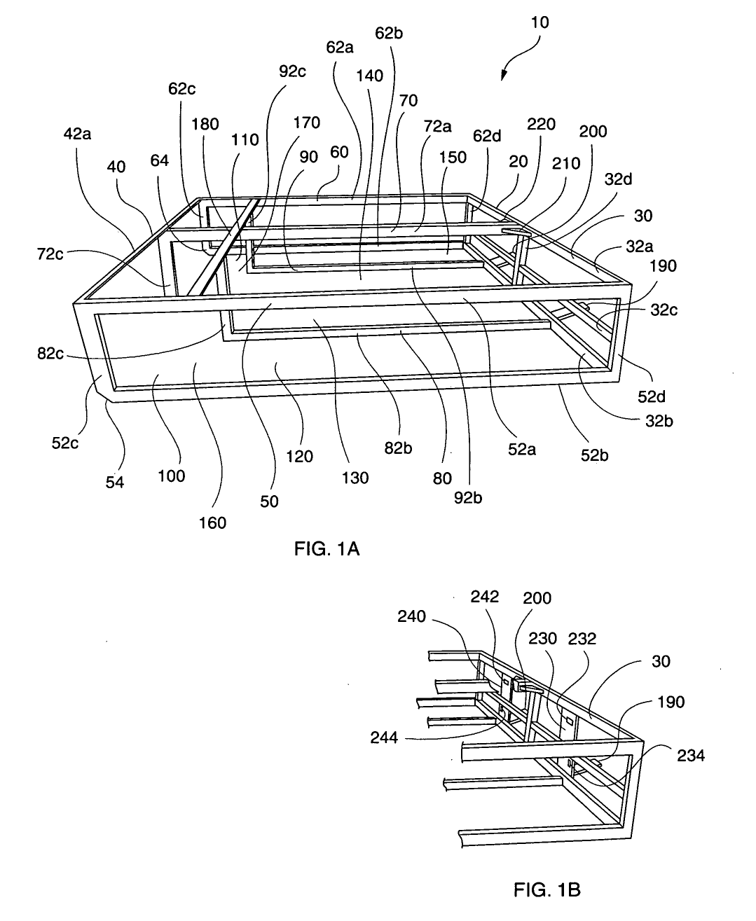

In describing the preferred and selected alternate embodiments of the present invention, as illustrated in FIGS. 1A-3, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1A-3, the present invention in a preferred embodiment is hay bale accumulator 10, wherein hay bale accumulator 10 preferably comprises frame 20. Frame 20 preferably comprises back 30, front 40, left side 50, right side 60, center 70, left separator 80, right separator 90, brace 180, left fillet 210 and right fillet 220. Left fillet 210 and right fillet 220 preferably provide stability to frame 20 and serve to positionally locate center 70 within frame 20.

Referring now more particularly to FIG. 1A, left side 50 preferably comprises top rail 52a, bottom rail 52b, front rail 52c, rear rail 52d and chamfer 54, wherein rails 52a, 52b, 52c and 52d generally form a rectangle. Right side 60 preferably comprises top rail 62a, bottom rail 52b, front rail 62c, rear rail 62b and chamfer 64, wherein rails 62a, 62b, 62c and 62d generally form a rectangle.

Center 70 preferably comprises top rail 72a, bottom rail 72b (best shown in FIG. 3), front rail 72c and chamfer 74 (best shown in FIG. 3), wherein rails 72a, 72b and 72c, together with center post 34d, generally form a rectangle. Left side 50, right side 60 and center 70 are disposed parallel to one another, wherein center 70 is disposed approximately equidistant from left side 50 and right side 60.

Back 30 of frame 20 preferably comprises top rail 32a, bottom rail 32b, middle rail 32c, center post 32d, left skid 190, and right skid 200. Front 40 preferably comprises top rail 42a. Back 30 is disposed perpendicular to left side 50, right side 60 and center 70, wherein left side 50, right side 60 and center 70 are fixedly attached to back 30 via welding or the like. Brace 180 and top rail 42a are also welded to left side 50, right side 60 and center 70, and constrain front rails 52c and 62c equidistant from front rail 72c, wherein front rail 42a and brace 180 comprise a top surface of frame 20.

Left separator 80 preferably comprises bottom guide 82b and front post 82c, and right separator 90 preferably comprises bottom guide 92b and front post 92c. Front posts 82c and 92c of left and right separators 80 and 90, respectively, are preferably disposed approximately one bale width aft of front rails 52c, 62c and 72c of left side 50, right side 60, and center 70, respectively.

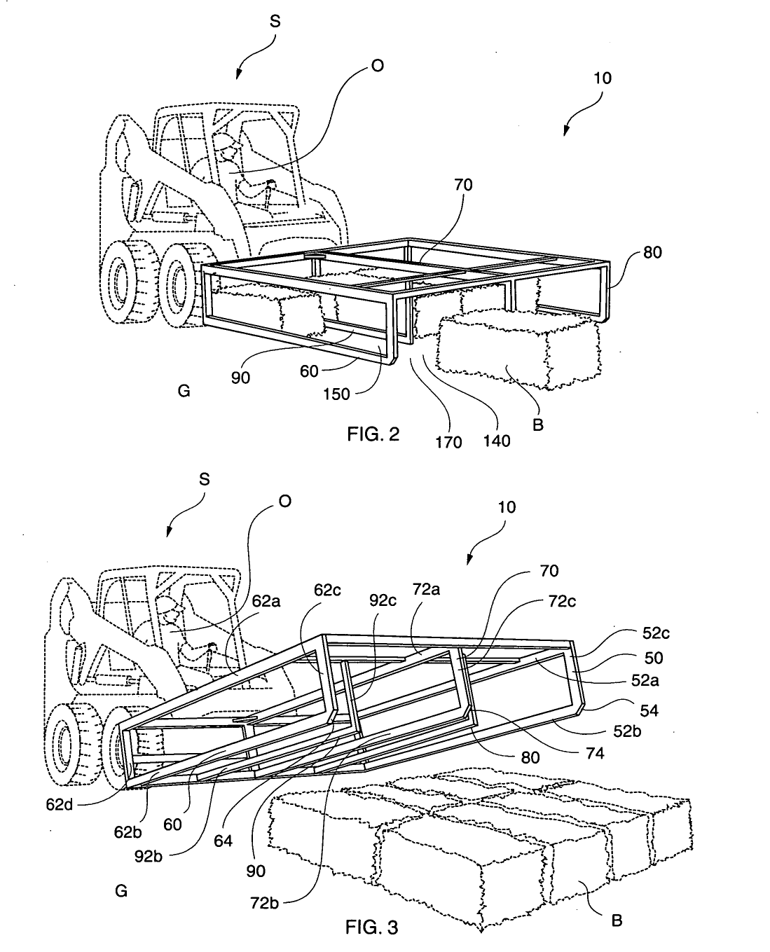

Left channel portion 100 preferably comprises first channel 120, second channel 130 and left enclosed entry section 160. Right channel portion 110 preferably comprises third channel 140, fourth channel 150 and right enclosed entry section 170. Left enclosed entry section 160 is defined by ground G (best shown in FIG. 2), top rail 42a, brace 180, left side 50 and center 70. Right enclosed entry section 170 is defined by ground G (best shown in FIG. 2), top rail 42a, brace 180, right side 50 and center 70.

Turning now more particularly to FIG. 1B, back 30 preferably comprises left attachment interface 230 and right attachment interface 240, wherein left attachment interface 230 preferably comprises top aperture 232 and bottom aperture 234, and wherein right attachment interface 240 preferably comprises top aperture 242 and bottom aperture 244. Apertures 232, 234, 242 and 244 preferably permit removable attachment of bale accumulator 10 to skid-steer propulsion unit S. Attachment of skid-steer propulsion unit S and bale accumulator 10 can be accomplished via any suitable fasteners as are known in the art.

Skid-steer propulsion unit S comprises a motive device known in the art that can pivot/spin in place, thereby permitting a high degree of maneuverability in tight locations.

In use, skid-steer drive or propulsion unit S is preferably removably secured to bale accumulator 10. Bale accumulator 10 is subsequently preferably pushed by skid-steer propulsion unit S across ground G and over bales B, wherein chamfers 54, 64 and 74 permit movement of bale accumulator 10 preferably with a reduction of elimination of damage to ground G. Bale B is preferably collected by bale accumulator 10 (as maneuvered by skid-steer propulsion unit S), wherein bale B preferably selectively enters left enclosed entry section 160 or right enclosed entry section 170, and wherein bale B is preferably subsequently easily captured. Upon entry into either left enclosed entry section 160 or right enclosed entry section 170, bale B's progress is preferably impeded by left front post 82c or right front post 92c, thereby preferably turning bale B and preferably selectively depositing same into one of channels 120, 130, 140 and 150. Upon accumulation of a selected quantity of bales B, bale accumulator 10 is preferably raised by skid-steer propulsion unit S, wherein left skid 190 and right skid 200 preferably make contact with ground G. Upon contact of left skid 190 and right skid 200 with ground G, operator O of skid-steer propulsion unit S knows that bale accumulator 10 has been raised above bales B an adequate distance to facilitate easy removal without disturbing bales B, and skid-steer propulsion unit S preferably subsequently withdraws slightly and pivots away from bales B, preferably leaving bales B disposed on ground G as a collected array for subsequent pick up. Alternately, bales B can continue to be pushed until bale accumulator 10 positions bales B at a collection point. Because of the ability of skid-steer propulsion unit S to pivot, collection of bales B can be performed in very tight areas and with close approach to any obstructions, such as fences or the like.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A bale accumulator comprising:
a framework, said framework comprising an enclosed entry section and a plurality of collection sections, wherein said framework further comprises at least one separator defining said plurality of collection sections.

2. The bale accumulator of claim 1, further comprising a skid-steer propulsion unit.

3. The bale accumulator of claim 2, wherein said framework is pushed by said skid-steer propulsion unit.

4. The bale accumulator of claim 1, wherein said framework further comprises a front, a rear frame, a left side frame, a right side frame, a center frame and a top.

5. The bale accumulator of claim 4, wherein said left and right side frames and said center frame comprise chamfered leading edges.

6. The bale accumulator of claim 4, wherein said rear frame comprises at least one attachment point.

7. The bale accumulator of claim 6, wherein a skid-steer propulsion unit is connected to said at least one attachment point.

8. The bale accumulator of claim 7, further comprising channels formed by separators, wherein at least one separator is disposed between said left side frame and said center frame, and at least one separator is disposed between said right side frame and said center frame.

9. The bale accumulator of claim 8, wherein said left, right and center frames each comprise a front rail, and wherein said separators each comprise a front rail, and wherein said separator front rails are disposed approximately one bale's width aft of said left, right and center frame front rails.

10. The bale accumulator of claim 1, wherein said enclosed entry section is enclosed by a ground surface and said framework.

11. The bale accumulator of claim 10, further comprising a skid-steer propulsion unit.

12. The bale accumulator of claim 11, further comprising:
left, center and right frames, wherein said left, center and right frames comprise front rails; and
left and right separators comprising front rails, wherein said separator front rails are disposed approximately one bale's width aft of said frame front rails.

13. A method of accumulating bales, said method comprising the steps of:
attaching a skid-steer propulsion unit to a bale accumulator comprising an enclosed entry section and a plurality of collection sections, wherein said bale accumulator further comprises at least one separator defining said plurality of collection sections; and
gathering hay bales within said bale accumulator.

14. The method of claim 13, wherein said step of gathering further comprises the steps of:
pushing said bale accumulator across a ground surface having the bales disposed thereupon; and
guiding said bale accumulator over the bales.

15. The method of claim 14, further comprising the step of:
pushing the bales across said ground surface until a selected quantity of bales has been accumulated.

16. The method of claim 15, further comprising the step of:
lifting said bale accumulator above the accumulated bales.

17. The method of claim 16, further comprising the step of:
moving said bale accumulator away from the bales by pivoting said skid-steer propulsion unit.

18. The method of claim 13, further comprising the step of:
guiding the bales into said enclosed entry section.

19. The method of claim 13, further comprising the step of:
removing said bale accumulator from the gathered bales.

20. A bale gathering apparatus comprising:
a bale accumulator disposed on a skid-steer propulsion unit, wherein said skid-steer propulsion unit pushes said bale accumulator.
